(19) United States
(12) Patent Application Publication
(10) Pub. No.: US 2025/0357775 A1
(43) Pub. Date: Nov. 20, 2025

(54) CONTROL DEVICE

(71) Applicant: NTT DOCOMO, INC., Tokyo (JP)

(72) Inventors: Masaki NAKAMURA, Chiyoda-ku (JP); Yuta TOYAMA, Chiyoda-ku (JP); Kazuhiko TAKENO, Chiyoda-ku (JP)

(73) Assignee: NTT DOCOMO, INC., Tokyo (JP)

(21) Appl. No.: 18/871,940

(22) PCT Filed: May 31, 2023
(86) PCT No.: PCT/JP2023/020243

§ 371 Date: Dec. 5, 2024

(30) Foreign Application Priority Data
Aug. 2, 2022 (JP) 2022-123164

(51) Int. Cl. H02J 7/00; H02J 7/34

(52) U.S. Cl. CPC H02J 7/00712; H02J 7/00032; H02J 7/0048; H02J 7/0063; H02J 7/0068; H02J 7/34; H02J 2300/24

(57) ABSTRACT

Provided is a control device capable of performing power control on a storage battery not to accelerate deterioration of the storage battery. A control unit 100 of a rectifier 10 is equivalent to a control device that controls a storage battery 13 configured to supply power to a load. The control unit 100 includes a power value acquisition unit 102 configured to acquire momentary power value information indicating power consumption of a communication device 14 from a smart meter 20, and a discharging execution unit 107 or a charging execution unit 108 configured to perform power control continuously for a prescribed time on the storage battery 13 based on the momentary power value information and suppress average power usage in a commercial power supply.

### TECHNICAL FIELD

The present invention relates to a control device that controls power.

### BACKGROUND ART

In recent years, while the use of natural energy such as solar power generation has attracted attention as measures for reduction of a power amount and power cost, solar power generators have been increasingly provided in facilities and houses. In the present situation, direct-current power generated by a solar power generator is mostly converted into an alternating current by a power conditioner and used. In this case, during a blackout such as in a disaster, the direct-current power generated by the solar power generator will not be supplied to a communication device. To supply generated power to a communication device even during a blackout from a viewpoint of securing power supply during a disaster, a direct-current power supply system is attracting attention.

In general, the power cost includes a basic charge and a power amount charge. Of these, the power amount charge is calculated by a power usage amount. Thus, for example, control of discharging a storage battery in a power supply system of communication equipment at a peak of power consumption is considered to be effective for cutting power consumption at peak times (so-called peak cut) (see Patent Literature 1 described below). The basic charge is a charge determined according to contract demand, and the contract demand is the greatest value among the maximum power demands of each month in the past one year. Since the maximum demand power is a greatest value in a month among average power usages (hereinafter, referred to as “demand value”) every 30 minutes, it is possible to reduce the basic charge by reducing the demand value.

### CITATION LIST

### Patent Literature

[0004][Patent Literature 1] Japanese Unexamined Patent Publication No. 2013-143867

### SUMMARY OF INVENTION

### Technical Problem

To reduce the basic charge, it is considered effective to discharge the storage battery in a power supply system of communication equipment at the peak of power consumption for use for peak cut.

On the other hand, there are two main factors that influence fluctuation of power consumption in a radio base station. There are a radio unit depending on traffic and an air-conditioning unit depending on an ambient temperature. It is difficult to predict the peak of power consumption since there is a possibility of unexpected occurrences. Even though power supply from a solar power generator is taken into account, since the output of the solar power generator significantly depends on the weather and is unstable, similarly, it is difficult to predict the peak of power consumption.

For this reason, a method for reducing a demand value by utilizing a smart meter having become widespread in recent years to determine feedback control of a storage battery as Expression (1) has been examined.

$${x}^{′} ( t ) = x ( t - 1 ) + P ( t ) - pTH$$

Here, P is a momentary power value that is acquired by the smart meter, X is a charging/discharging amount (discharging: positive, charging: negative), and Pth is a control value that is a target value of an average power usage of alternating-current power. From Expression (1), a schedule charging/discharging amount x′ is determined based on the momentary power value P, the control value Pth, and a previous charging/discharging amount x(t-1) that is a previous charging/discharging amount of the storage battery.

It is assumed that, when charging is performed within a range of satisfying a chargeable SOC, and discharging is performed within a range of satisfying a dischargeable SOC, x(t)=x′(t) is established. Since it is important to secure a backup capacity of the storage battery in a radio base station from a viewpoint of a measure for disaster such as a blackout, a dischargeable state of charge (SOC) range is determined. A chargeable SOC range is determined in the same manner to prevent overcharging from a viewpoint of battery protection.

However, this method has a problem in that, since control of the charging/discharging amount of the storage battery is required, an expensive charging/discharging circuit is needed, and in a case where the power consumption of the communication device is around a threshold, there is a possibility that charging/discharging will be repeated, accelerating deterioration of the storage battery.

Accordingly, to solve the above-described problems, an object of the present invention is to provide a control device capable of performing power control on a storage battery to prevent acceleration of deterioration of the storage battery without using an expensive charging/discharging circuit.

### Solution to Problem

A control device of the present invention is a control device that controls a storage battery configured to supply power to a load, the control device including an acquisition unit configured to a momentary power value information indicating power consumption, and a control unit configured to perform power control on the storage battery continuously over a prescribed time based on the momentary power value information and reduce an average power usage in a commercial power supply.

### Advantageous Effects of Invention

According to the present invention, the power control of the storage battery is performed continuously over the prescribed time based on the momentary power value, and control with suppressed deterioration of the storage battery can be performed.

### BRIEF DESCRIPTION OF DRAWINGS

FIG. 1 is a diagram illustrating a functional configuration of a direct-current power supply system of a radio base station in the present disclosure.

FIG. 2 is a block diagram illustrating a functional configuration of a control unit 100.

FIG. 3 is a flowchart illustrating an operation of power control of the control unit 100.

FIG. 4 is a flowchart illustrating an operation of the control unit 100 during discharging processing.

FIG. 5 is a flowchart illustrating an operation of the control unit 100 for charging processing.

FIG. 6 is a diagram illustrating a control image.

FIG. 7 is a diagram illustrating a functional configuration of a direct-current power supply system using a solar power generator 30.

FIG. 8 is a diagram illustrating an example of a hardware configuration of the control unit 100 according to an embodiment of the present disclosure.

### DESCRIPTION OF EMBODIMENTS

An embodiment of the present disclosure will be described with reference to the accompanying drawings. If possible, the same parts are represented by the same reference signs, and duplicate description thereof will not be repeated.

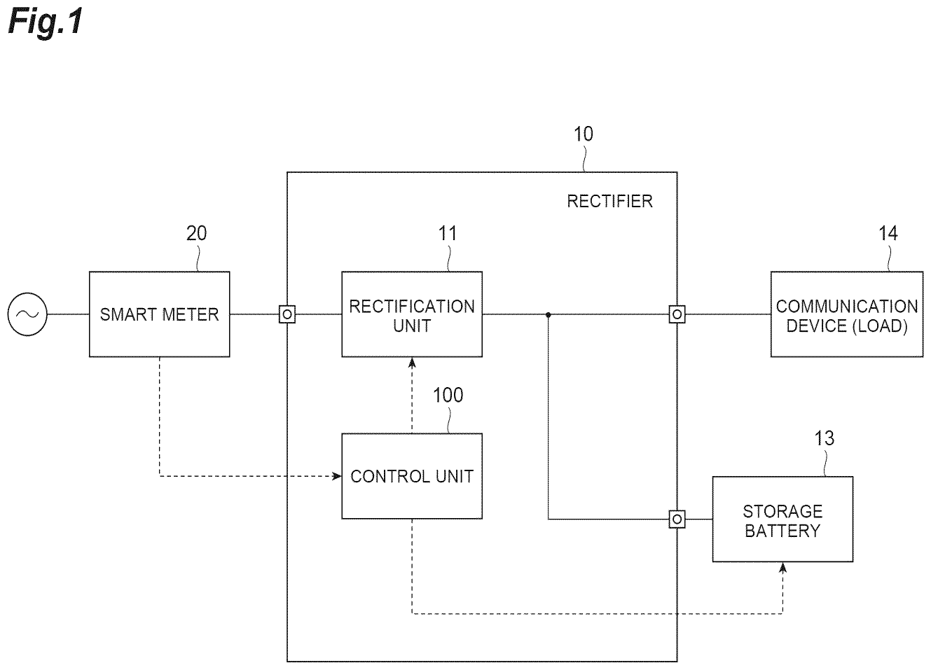

FIG. 1 is a diagram illustrating a functional configuration of a direct-current power supply system of a radio base station in the present disclosure. As illustrated in the drawing, the direct-current power supply system is configured with a rectifier 10, a storage battery 13, and a communication device 14 (load device) to which direct-current power is supplied from the rectifier and the storage battery.

The rectifier 10 includes a rectification unit 11 and a control unit 100. The rectification unit 11 is a part that converts an alternating current from an alternating-current power supply into a direct current. In the present disclosure, the rectifier 10 (rectification unit 11) supplies power to the communication device 14 and the storage battery 13 according to voltage control by the control unit 100.

The control unit 100 is a part that performs output voltage control of the rectification unit 11. For example, the control unit 100 can control the charging/discharging of the storage battery 13 by setting a rectifier voltage to be higher than a voltage of the storage battery 13 for charging and setting the rectifier voltage to be lower than the voltage of the storage battery 13 for discharging. The control unit 100 is a part that acquires a momentary power value and a 30-minute integrated power value from B route data of a smart meter 20.

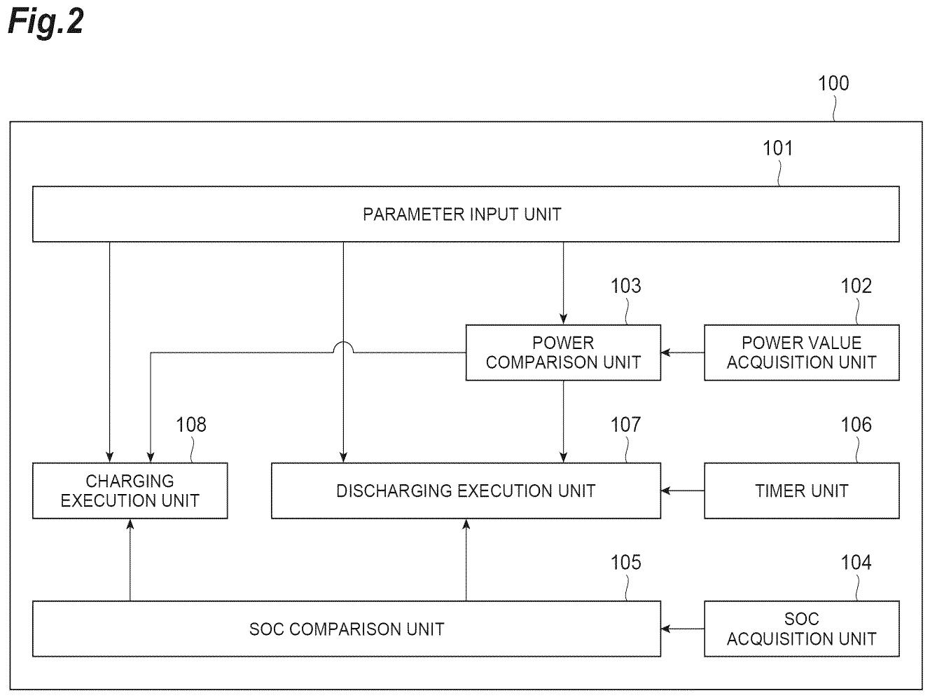

Next, the configuration of the control unit 100 will be described. FIG. 2 is a block diagram illustrating a functional configuration of the control unit 100. As illustrated in the drawing, the control unit 100 includes a parameter input unit 101, a power value acquisition unit 102, a power comparison unit 103, an SOC acquisition unit 104, an SOC comparison unit 105, a timer unit 106, a discharging execution unit 107, and a charging execution unit 108.

The parameter input unit 101 is a part that is provided to input a discharging threshold Pu and a charging threshold P1. The thresholds are values set in advance, and are values set by a system operator. The input parameters are stored in a memory (not illustrated) in the parameter input unit 101.

The power value acquisition unit 102 is a part that acquires a momentary power value P(t) detected in the smart meter 20. The momentary power value P(t) indicates a power value at time t.

The power comparison unit 103 is a part that compares the momentary power value P(t) with each threshold (discharging threshold Pu and charging threshold P1).

The SOC acquisition unit 104 acquires a current SOC of the storage battery 13, a chargeable SOC (for example, 100%), and a dischargeable SOC (for example, 60%). While the chargeable SOC is set to, for example, 100%, the chargeable SOC may be set to 95% in a case where a charging region is desired to be constantly secured.

The SOC comparison unit 105 is a part that compares the chargeable SOC and the dischargeable SOC with the current SOC of the storage battery 13.

The timer unit 106 is a part that measures a time.

The discharging execution unit 107 is a part that executes discharging based on the current SOC, the dischargeable SOC, and the discharging threshold while referring to the time of the timer unit 106. For example, the discharging execution unit 107 performs discharging by making the rectifier voltage lower than the storage battery voltage (for example: V_{D}=45 V) until T′ obtained by adding a set time T to time T₀ at which the momentary power value exceeds the discharging threshold is reached, when the current SOC is equal to or greater than the dischargeable SOC, and thereafter, the discharging execution unit 107 is in a waiting state until a time frame ends. In the present disclosure, the time frame is a time unit determined in advance, and is, for example, every 30 minutes. A start point of the time frame is determined as 0 minutes past the hour and 30 minutes past the hour. This is a measurement unit for average power usage measurement. In general, the average power usage is referred to as a demand value, and the basic charge is determined based on the demand value in a high-voltage power contract.

The charging execution unit 108 is a part that executes charging based on the current SOC of the storage battery 13 and the chargeable SOC while referring to the time of the timer unit 106. For example, the charging execution unit 108 performs charging by making the rectifier voltage higher than the storage battery voltage (for example, Vu=54 V) in a charging period until the SOC reaches the chargeable SOC, the charging period ends, or the momentary power value exceeds the discharging threshold, when the current SOC is equal to or lower than the chargeable SOC.

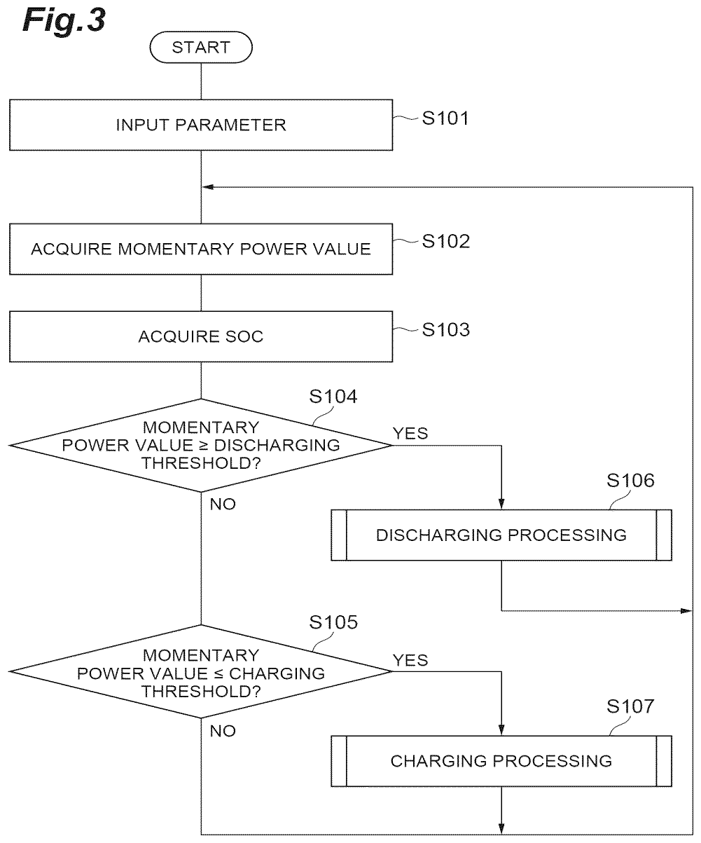

FIG. 3 is a flowchart illustrating an operation of power control of the control unit 100.

The parameter input unit 101 receives the input of the discharging threshold Pu and the charging threshold P1 and stores the discharging threshold Pu and the charging threshold P1 (S101). The power value acquisition unit 102 acquires the momentary power value P(t) (S102). The SOC acquisition unit 104 acquires the SOC of the storage battery 13 (S103).

The power comparison unit 103 compares the momentary power value P(t) with the discharging threshold Pu (S104). Here, if the power comparison unit 103 determines that a relationship of momentary power value P(t)≥discharging threshold Pu is established (S104: YES), the discharging execution unit 107 performs discharging processing (S106).

If the power comparison unit 103 determines that the relationship of momentary power value P(t)≥discharging threshold Pu is not established (S104: NO), and the power comparison unit 103 further determines that a relationship of momentary power value P(t)≤charging threshold P1 is established (S105: YES), the charging execution unit 108 performs charging processing (S107).

If the power comparison unit 103 determines that the relationship of momentary power value P(t)≤charging threshold P1 is not established (S105: NO), the process returns to S102, and further performs the acquisition of the momentary power value and the acquisition of the SOC of the storage battery 13. It is assumed that discharging thresholdP>charging threshold P1.

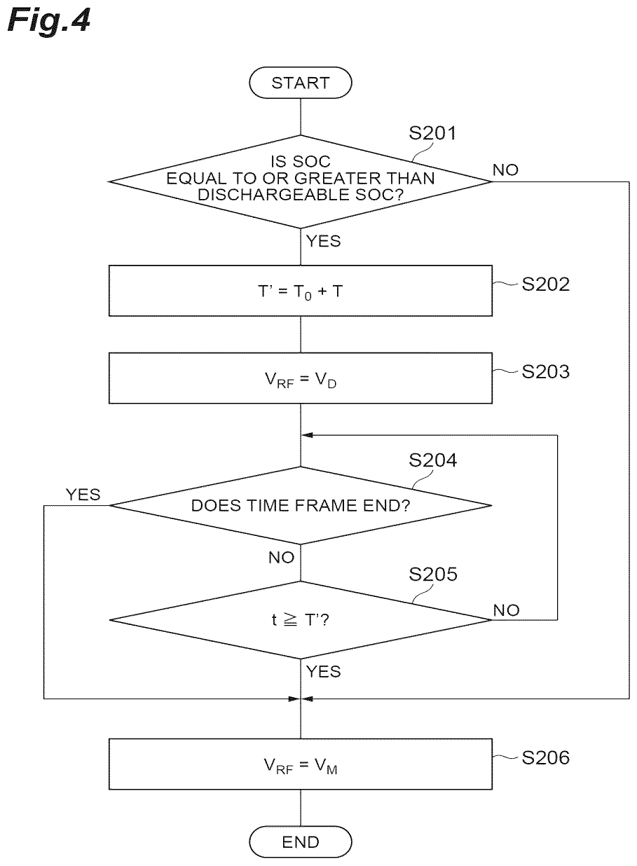

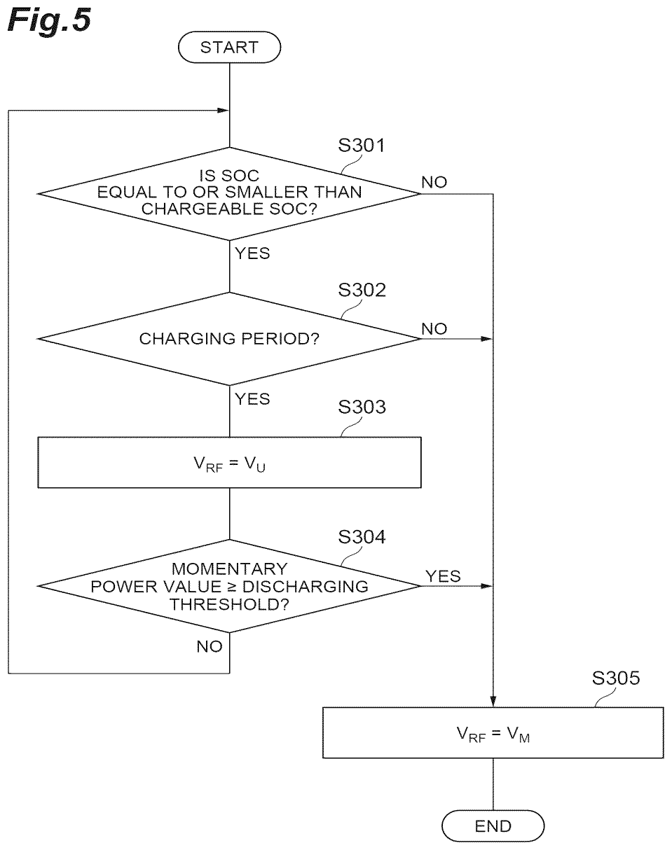

Next, the discharging processing and the charging processing will be described in more detail using FIGS. 4 and 5. FIG. 4 is a flowchart illustrating an operation of the control unit 100 during the discharging processing.

The SOC comparison unit 105 determines whether the current SOC of the storage battery 13 acquired by the SOC acquisition unit 104 is equal to or greater than the dischargeable SOC (S201). If the SOC comparison unit 105 determines that the current SOC is equal to or greater than the discharging SOC (S201: YES), the discharging execution unit 107 calculates T′ obtained by adding the set time T to time T₀ at which the momentary power value exceeds the discharging threshold (S202). Then, the discharging execution unit 107 sets the rectifier voltage to be lower than the storage battery voltage (S203). For example, in a case where the storage battery voltage is 48 V, the rectifier voltage V_{RF} is set to V_{D} (for example, 45 V).

Then, the discharging execution unit 107 performs the discharging processing until one time frame of the time T′ ends or a current time t reaches time T′ (S204, S205). If one time frame ends or time T′ is reached, the discharging execution unit 107 sets the rectifier voltage V_{RF} to V_{M} (for example, 52 V), and stops the discharging processing (S206).

If the time frame ends before time T′ is reached, the discharging execution unit 107 sets the rectifier voltage V_{RF} to V_{M} (for example, 52 V) at this time (S204: YES), and stops the discharging processing (S206). The time frame is any of 0 minutes past the hour and 30 minutes past the hour as described above, and is a period of a prescribed time determined in advance.

If time T′ is reached before the end of one time frame (S205: YES), the discharging execution unit 107 sets the rectifier voltage V_{RF} to V_{M} (for example, 52 V), and ends the discharging processing (S206).

In such a manner, in a case where 0 minutes past the hour or 30 minutes past the hour are reached, discharging ends even though the set time T does not elapse. Specifically, when the discharging threshold is 8 kw, and the set time T is 10 minutes, in a time frame 2 (0:30-1:00), in a case where a momentary power value of 8.1 kW is measured at 0:55, discharging is performed until 1:00, and thereafter, transition is made to waiting. Next, in a time frame 3 (1:00-1:30), in a case where a momentary power value of 8.1 kW is measured at 1:11, discharging is performed until 1:21, and thereafter, transition is made to waiting.

While a case where the above-described set time T is a fixed value has been described, the set time T may be variable. For example, the set time T may be changed according to a communication traffic volume of the communication device 14. When the communication traffic volume is large, and a lot of power is consumed, the set time T should be set to be long. In the present disclosure, since discharging control ends for every time frame, the set time T is changed based on the communication traffic amount at a start time of the time frame. The control unit 100 may acquire the communication traffic amount of the communication device 14 or may be based on the momentary power value of the smart meter. That is, the control unit 100 may set the set time to be long according to the magnitude of the momentary power value at the time of the start of the time frame (or may be a prescribed short time at the beginning of the time frame).

Next, charging will be described. FIG. 5 is a flowchart illustrating an operation of the control unit 100 for the charging processing. The SOC comparison unit 105 determines whether the current SOC of the storage battery 13 is equal to or smaller than the chargeable SOC (S301). Then, in a case where the current SOC is equal to or smaller than the chargeable SOC, and the charging period is performed (S302: YES), the charging execution unit 108 sets the rectifier voltage V_{RF} to V_{U} (for example, 54 V) (S303). With this, the rectifier voltage can be set to be higher than the storage battery voltage (48 V), and can be charged to the storage battery 13. Then, the charging execution unit 108 repeats such processing until the current SOC of the storage battery 13 reaches the chargeable SOC or the relationship of momentary power value≥discharging threshold is established (S304: NO).

The charging execution unit 108 sets the rectifier voltage V_{RF} to V_{M} if the charging period ends (S302: NO), the current SOC of the storage battery 13 reaches the chargeable SOC (S301: NO), or the relationship of momentary power value≥discharging threshold is established (S302: YES), and ends the charging processing (S305).

Specifically, when the discharging threshold is 8 kW, the charging threshold is 6 kW, and the charging period is 3:00-6:00 (time frames 7 to 12), in a case where the power value acquisition unit 102 measures a momentary power value of 4.9 kW at 3:32 in the time frame 8 (3:30-4:00), the charging execution unit 108 is instructed to perform charging until 6:00. Next, in the time frame 10 (4:30-5:00), in a case where power value acquisition unit 102 measures a momentary power value of 8.1 kW, the charging execution unit 108 sets the rectifier voltage to stop the charging processing. Next, in the time frame 11 (5:00-5:30), in a case where a momentary power value of 4.9 kW is measured at 5:00, the charging execution unit 108 is instructed to perform charging until 6:00.

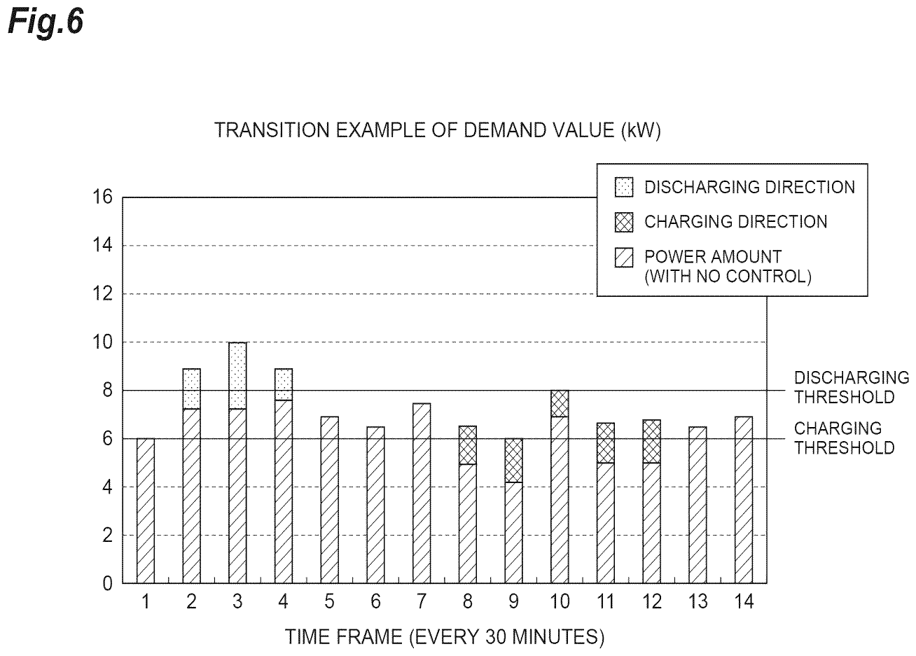

Next, a transition example of the demand value will be described. FIG. 6 is a diagram illustrating a control image for explaining a power value with no control and a power value with control. As illustrated in the drawing, the average power usage (demand value) in the time frame 2 to the time frame 4 in a case where there is no control indicates a value greater than the discharging threshold. If the rectifier 10 (control unit 100) of the present disclosure is used, control of a charging direction is performed, and a dotted-line portion is eliminated by discharging control. With this, the demand value decreases, and it is possible to contribute to reduction of the basic charge.

On the other hand, the average power usage (demand value) in the time frames 7 to 12 increases with the charging control. In the time frame 10, when the discharging threshold is reached, the charging control is stopped, and as expected, the average power usage can be reduced.

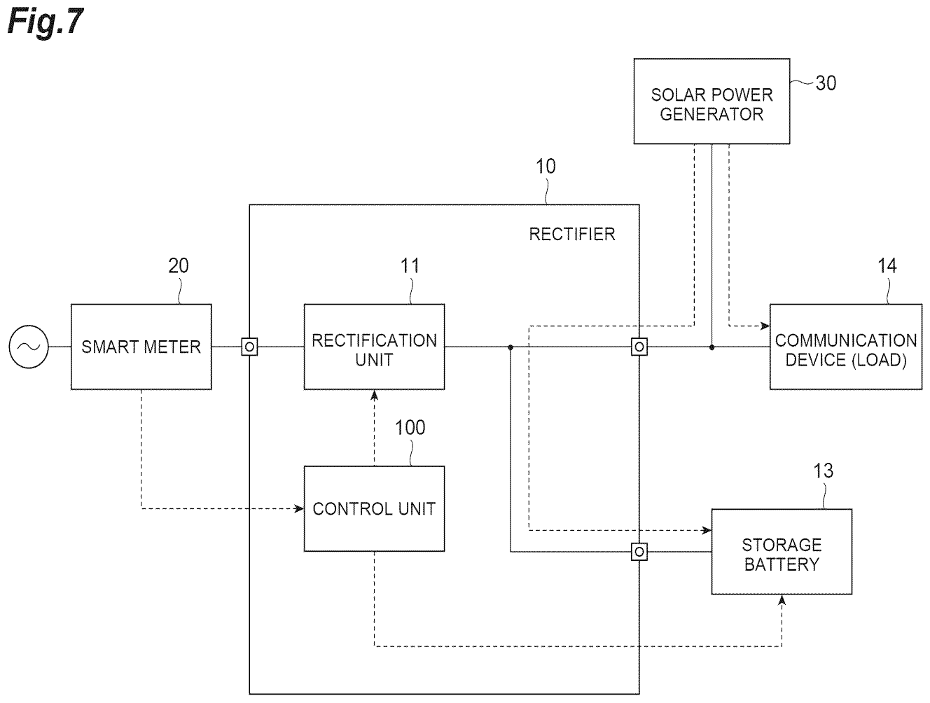

Next, a direct-current power supply system using a solar power generator 30 will be described. FIG. 7 is a diagram illustrating a functional configuration of the direct-current power supply system. As illustrated in the drawing, the direct-current power supply system has a system configuration in which the solar power generator 30 is further provided to the direct-current power supply system in FIG. 1.

In a case of connecting the solar power generator 30 to the direct-current power supply system, the solar power generator is connected directly to a 48 V bus, so that the generated power of the solar power generator 30 is preferentially supplied to the communication device 14 even during a blackout. An output voltage of the solar power generator 30 is set to be equal to or greater than a rectifier output voltage within a range of satisfying an input voltage range of the communication device 14, so that the generated power of the solar power generator 30 can be preferentially supplied to the communication device 14.

That is, as illustrated in FIG. 7, the power generated by the solar power generator 30 is supplied to the communication device 14, and surplus power is supplied (charged) to the storage battery 13. The surplus power is power obtained by subtracting the power consumption of the communication device 14 from the power generated by the solar power generator 30. The control unit 100 can perform control to charge the power generated by the solar power generator 30 to the storage battery 13 by controlling a voltage of the rectification unit 11 based on a generated voltage of the solar power generator 30 and a momentary power value of the smart meter 20.

Next, the operation and effects of the control unit 100 of the present disclosure will be described. The control unit 100 of the present disclosure is equivalent to a control device that controls the storage battery 13 configured to supply power to a load. The control unit 100 includes the power value acquisition unit 102 that acquires momentary power value information indicating the power consumption of the communication device 14 from the smart meter 20, and the discharging execution unit 107 or the charging execution unit 108 that performs power control on the storage battery 13 continuously over a prescribed time based on the momentary power value information and reduces an average power usage in a commercial power supply.

With this configuration, the power control, for example, discharging control or charging control on the storage battery 13 is performed based on the momentary power value information.

Accordingly, it is possible to prevent the frequent charging/discharging of the storage battery. The power value acquisition unit 102 can acquire the momentary power value information from the smart meter 20.

Then, for example, the discharging execution unit 107 performs control of discharging the storage battery 13 for a prescribed time in a case where the momentary power value information is equal to or greater than the discharging threshold. The prescribed time is set to, for example, ten minutes. The prescribed period may be determined according to a use state of a load such as the communication device 14, for example, a power usage. The use state is based on a state at a start time of a unit time (for example, 30 minutes) for measurement of an average power usage (demand value).

The charging execution unit 108 may perform control of charging the storage battery 13 for a prescribed time even though the momentary power value information does not exceed the discharging threshold, in a case where the momentary power value information is equal to or smaller than the charging threshold.

With this, even though the momentary power value information is equal to or smaller than the discharging threshold and equal to or greater than the charging threshold, charging or discharging is performed continuously over at least the prescribed time. Accordingly, it is possible to prevent the repetitive charging/discharging of the storage battery.

The discharging execution unit 107 ends the discharging control before a prescribed time elapses if a unit period of the average power usage is reached. The average power usage is based on a value obtained by integrating the momentary power value acquired as B route data from the smart meter 20 and taking an average in terms of a unit time (for example, one minute). The discharging execution unit 107 ends the discharging control when 0 minutes past the hour and 30 minutes past the hour are reached before the prescribed time elapses.

With this, even in the middle of the discharging, the discharging is stopped once in the unit period. Thus, it is possible to prevent the average usage (demand value) in the unit period from exceeding the discharging threshold, and as a result, it is possible to appropriately perform the charging/discharging of the storage battery 13.

The charging execution unit 108 performs control of charging the storage battery 13 in a case where the SOC (battery capacity) of the storage battery 13 is equal to or smaller than a prescribed value and a charging period determined in advance is performed.

With this, a time period in which it is known in advance that the power usage amount of the communication device 14 is small is defined as a charging period, and in this period, charging to the storage battery 13 is controlled to be preferentially performed. Thus, it is possible to reduce the charging frequency of the storage battery 13.

The charging execution unit 108 ends the charging to the storage battery 13 in a case where the SOC (battery capacity) of the storage battery 13 exceeds the discharging threshold determined in advance.

With this, it is possible to prevent overcharging to the storage battery 13, and to prevent deterioration of the storage battery 13.

The rectifier 10 (control unit 100) of the present disclosure performs control for supplying power from the solar power generator 30 to the storage battery 13 or the communication device 14 that is the load.

The control unit 100 performs control to supply the power generated by the solar power generator 30 to the communication device 14 and the storage battery 13 based on the momentary power value information. That is, based on the voltage control on the rectification unit 11 by the control unit 100, the solar power generator 30 can supply power obtained by solar power generation to the communication device 14, and can charge the storage battery 13 using the surplus power.

The control device disclosed herein comprises the following configuration.

[1]A control device that controls a storage battery configured to supply power to a load, the control device comprising:
an acquisition unit configured to acquire momentary power value information indicating power consumption; and
a control unit configured to perform power control on the storage battery continuously over a prescribed time based on the momentary power value information and reduce a power usage in a commercial power supply.

[2] The control device according to [1],
wherein the control unit is configured to perform control of discharging the storage battery for a prescribed time in a case where the momentary power value information is equal to or greater than a discharging threshold.

[3] The control device according to [2],
wherein the control unit is configured to end discharging control before the prescribed time elapses when a measurement unit time for average power usage measurement is reached.

[4] The control device according to any one of [1] to [3],
wherein the prescribed time is set to be variable according to a use state of the load.

[5] The control device according to [4],
wherein the use state is based on a state at a start time of a measurement unit time for average power usage measurement.

[6] The control device according to any one of [1] to [5],
wherein the control unit is configured to perform control of charging the storage battery in a case where a battery capacity of the storage battery is equal to or less than a prescribed value and a charging period determined in advance is reached.

[7] The control device according to [6],
wherein the control unit is configured to end charging to the storage battery in a case where the battery capacity of the storage battery exceeds a discharging threshold determined in advance.

[8] The control device according to any one of [1] to [7],
wherein the control device is configured to perform control for supplying power from a solar power generator to the storage battery or the load, and
the control unit is configured to perform control to supply power generated in the solar power generator to the load or the storage battery, based on the momentary power value information.

[9] The control device according to any one of [1] to [8],
wherein the acquisition unit acquires momentary power value information from a smart meter.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

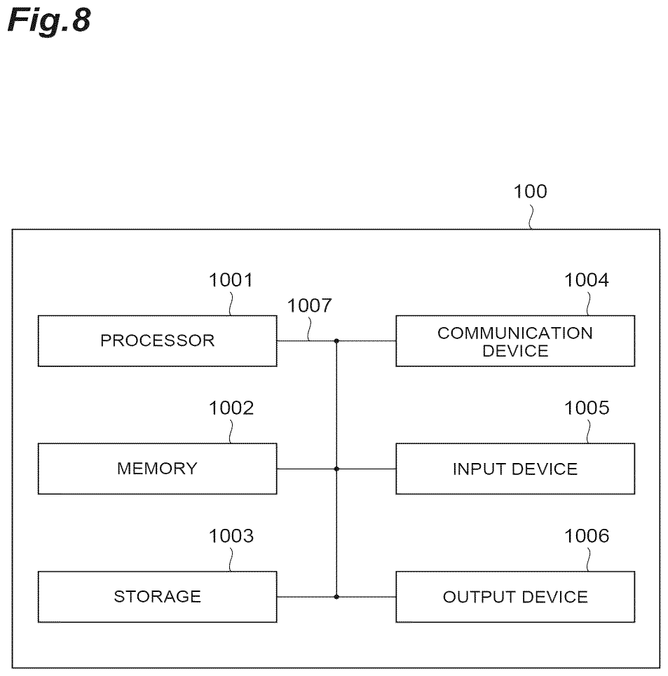

For example, the control unit 100 and the like according to one embodiment of the present disclosure may function as a computer that performs processing of a power control method or a conversation information generation method according to the present disclosure. FIG. 8 is a view showing an example of the hardware configuration of the control unit 100 according to one embodiment of the present disclosure. The control unit 100 described above may be physically configured as a computer device that includes a processor 1001, a memory 1002, a storage 1003, a communication device 1004, an input device 1005, an output device 1006, a bus 1007 and the like. In FIG. 8, while the control unit 100 is described as the computer device including the storage 1003, the communication device 1004, the input device 1005, and the output device 1006 as an example, these devices may not be of course provided, and the control unit 100 may be configured with the processor 1001 and the memory 1002.

In the following description, the term “device” may be replaced with a circuit, a device, a unit, or the like. The hardware configuration of the control unit 100 may be configured to include one or a plurality of the devices shown in the drawings or may be configured without including some of those devices.

The functions of the control unit 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the power comparison unit 103 and SOC comparison unit 105 described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, control unit 100 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing the power control method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the power value acquisition unit 102 may be implemented by the communication device 1004.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the control unit 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (NIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

10 Rectifier, 11 Rectification unit, 13 Storage battery, 14 Communication device, 20 Smart meter, 30 Solar power generator, 100 Control unit, 101 Parameter input unit, 102 Power value acquisition unit, 103 Power comparison unit, 104 SOC acquisition unit, 105 SOC comparison unit, 106 Timer unit, 107 Discharging execution unit, 108 Charging execution unit.

1. A control device that controls a storage battery configured to supply power to a load, the control device comprising:
an acquisition unit configured to acquire momentary power value information indicating power consumption; and
a control unit configured to perform power control on the storage battery continuously over a prescribed time based on the momentary power value information and reduce a power usage in a commercial power supply.

2. The control device according to claim 1,
wherein the control unit is configured to perform control of discharging the storage battery for a prescribed time in a case where the momentary power value information is equal to or greater than a discharging threshold.

3. The control device according to claim 2,
wherein the control unit is configured to end discharging control before the prescribed time elapses when a measurement unit time for average power usage measurement is reached.

4. The control device according to claim 1,
wherein the prescribed time is set to be variable according to a use state of the load.

5. The control device according to claim 4,
wherein the use state is based on a state at a start time of a measurement unit time for average power usage measurement.

6. The control device according to claim 1,
wherein the control unit is configured to perform control of charging the storage battery in a case where a battery capacity of the storage battery is equal to or less than a prescribed value and a charging period determined in advance is reached.

7. The control device according to claim 6,
wherein the control unit is configured to end charging to the storage battery in a case where the battery capacity of the storage battery exceeds a discharging threshold determined in advance.

8. The control device according to claim 1,
wherein the control device is configured to perform control for supplying power from a solar power generator to the storage battery or the load, and
the control unit is configured to perform control to supply power generated in the solar power generator to the load or the storage battery, based on the momentary power value information.

9. The control device according to claim 1,
wherein the acquisition unit acquires momentary power value information from a smart meter.
